(19) United States
(12) Patent Application Publication
(10) Pub. No.: US 2023/0257302 A1
(43) Pub. Date: Aug. 17, 2023

(54) PARALLEL-FLOW REGENERATIVE SHAFT KILN AND METHOD FOR CALCINING CARBONATE ROCK

(71) Applicants: Maerz Ofenbau AG, Zurich (CH); thyssenkrupp AG, Essen (DE); thyssenkrupp Industrial Solutions AG, Essen (DE)

(72) Inventor: Hannes PIRINGER, Beinwil am See (CH)

(73) Assignees: Maerz Ofenbau AG, Zurich (CH); thyssenkrupp AG, Essen (DE); thyssenkrupp Industrial Solutions AG, Essen (DE)

(21) Appl. No.: 18/017,166

(22) PCT Filed: Jul. 7, 2021
(86) PCT No.: PCT/EP2021/068842

§ 371 Date: Jan. 20, 2023

(30) Foreign Application Priority Data
Jul. 20, 2020 (DE) 10 2020 004 372.0

(51) Int. Cl. C04B 2/12; F27B 1/02; F27B 1/00; F27B 1/24; F27B 1/26; F27D 7/06

(52) U.S. Cl. CPC C04B 2/12; F27B 1/02; F27B 1/005; F27B 1/24; F27B 1/26; F27D 7/06; F27D 2007/063; F27D 2019/0009

(57) ABSTRACT

A method for calcining and cooling material such as carbonate rocks may be employed in a parallel-flow regenerative shaft kiln that has two shafts, which are operated alternately as a calcining shaft and as a regenerative shaft. Material flows through a preheating zone, a calcining zone, and a cooling zone to a product outlet. At least one gas flow is compressed by a high-pressure fan and introduced into the parallel-flow regenerative shaft kiln. The high-pressure fan is configured as an axial fan or as a radial fan, having an impeller through which flow takes place axially or radially. A parallel-flow regenerative shaft kiln may also be utilized to perform such methods.

The invention relates to a parallel-flow regenerative shaft kiln (PFR shaft kiln) and also to a method for calcining and cooling material, such as carbonate rocks, with a PFR shaft kiln which has a high-pressure fan.

Calcining of carbonate rock in a PFR shaft kiln has been known for about 60 years. A PFR shaft kiln of this kind, known for example from WO 2011/072894 A1, has two vertical, parallel shafts which operate cyclically, with calcining being performed only in one shaft, the respective calcining shaft, while the other shaft operates as a regenerative shaft. The calcining shaft is fed with oxidizing gas in parallel flow with the material and fuel, and the resultant hot off-gases are conducted, together with the warmed cooling air fed from below, via the overflow duct into the off-gas shaft, where the off-gases are conducted off upward in countercurrent flow to the material, with the material being preheated in the process. The material is typically charged into the shaft from above, together with the oxidizing gas, with fuels being injected in the calcining zone.

In each shaft, the material for calcining typically passes through a preheating zone for preheating the material, a downstream calcining zone, in which the material is calcined, and a downstream cooling zone, in which cooling air is fed to the hot material.

The process gases, such as fuel gases, cooling air, and combustion air, for example, are introduced typically under a pressure of 300 to 400 mbar into the calcining shaft. This conveying pressure is presently generated by means of a rotary blower or a screw compressor, these devices having an efficiency of about 60% to 70%. Rotary blowers or screw compressors in particular have the substantial advantage that they supply a quantity of air which is strictly proportional to the rotary speed, and which changes only very little as a function of the opposing pressure. A further advantage is that prior to the changeover to the other kiln shaft, the air is able to flow off into the surroundings, with a drop in the power consumption for the rotary blowers or screw compressors. A disadvantage is the low efficiency. Particularly when using fuel gases having a low calorific value, such as blast-furnace off-gases, for example, the volume flows requiring compression are great. The compression of the process gases is very energy-intensive and there are efforts made to lower the power consumption of a PFR shaft kiln.

On this basis, the object of the present invention is to provide a PFR shaft kiln, and a method for calcining carbonate rock with a PFR shaft kiln, which have a lower energy demand for compression of the process gases than do known PFR shaft kilns and methods for calcining carbonate rock with a PFR shaft kiln.

This object is achieved in accordance with the invention by an apparatus having the features of independent method claim 1 and by a method having the features of independent apparatus claim 8. Advantageous developments are apparent from the dependent claims.

According to a first aspect, the invention embraces a method for calcining and cooling material, such as carbonate rocks, in a parallel-flow regenerative shaft kiln having two shafts, which are operated alternately as calcining shaft and as regenerative shaft, wherein the material flows through a preheating zone, at least one calcining zone, and a cooling zone to a product outlet.

At least one gas stream is compressed by means of a high-pressure fan and introduced into the parallel-flow regenerative shaft kiln.

The parallel-flow regenerative shaft kiln has at least two shafts, which are preferably disposed parallel to one another and vertically. The shafts can be operated alternately as calcining shaft and as regenerative shaft, and each shaft, in the flow direction of the material, has a preheating zone for preheating the material, a calcining zone for calcining the material, and a cooling zone for cooling the material. Each shaft preferably has a materials inlet to let material for calcining into the shaft, with the materials inlet being located more particularly at the upper end of the respective shaft, so that the material falls by gravity into the respective shaft.

The fuel comprises, for example, a fuel gas, such as blast-furnace gas, having a calorific value of less than 6.6 MJ/Nm³, or natural gas. The fuel is charged for example into the preheating zone or the calcining zone of the respective shaft.

In accordance with the invention the gas flows which are fed to the shaft, more particularly to the calcining shaft, are compressed by means of one or a plurality of high-pressure fans. A high-pressure fan preferably comprises a fan which is configured in such a way that it compresses the gas stream to a pressure of about 300 mbar to 500 mbar, more particularly 400 mbar. The high-pressure fan is preferably configured as an axial fan or as a radial fan, with an impeller through which flow takes place axially or radially, the impeller preferably rotating in a housing. The speed of the high-pressure fan is adjusted preferably by way of a frequency converter connected to the fan. Unlike a conventional compressor, such as a rotary blower, for example, the high-pressure compressor has a characteristic line, more particularly pressure-volume characteristic line or power curve, which does not have a linear profile.

A high-pressure fan of this kind offers the advantage of a very low power consumption relative to alternative compressors, with the reliable generation at the same time of a positive pressure of about 400 mbar in the shaft. The invention is based on the finding that a high-pressure fan offers sufficient operational reliability, even in a switchover procedure where the functions of the calcining shaft and of the regenerative shaft are switched, and ensures a sufficient pressure drop in the shaft operated as calcining shaft in the case of a switchover procedure.

According to a first embodiment, the gas streams compressed by means of the one or the plurality of high-pressure fans comprise: a cooling air flow which is introduced into the cooling zone; a combustion air flow which is introduced into the preheating zone and/or the calcining zone; and/or a fuel gas flow which is introduced into the preheating zone and/or the calcining zone. It is likewise conceivable for a cooling air flow which is conducted along the outer wall of the shaft, preferably through the lower part of the refractory lining of the calcining zone, to be compressed by means of the one or the plurality of high-pressure fans.

Each shaft preferably has a plurality of burner lances, which extend into the preheating zone and more particularly into the calcining zone of the respective shaft and serve for conducting, for example, fuel gas and/or an oxidizing gas, such as air or oxygen-enriched air or pure oxygen.

According to a further embodiment, for the switchover between the operation of a shaft as calcining shaft and the operation of the shaft as regenerative shaft, at least the following method steps preferably take place:

a. ending the feeding of fuel into the shaft operated as calcining shaft, and

b. reducing the speed of the high-pressure fan by not more than 50% to 65%, and/or closing a shutoff facility between the high-pressure fan and the shaft, so that less of or none of the gas flow compressed by means of the respective high-pressure fan enters the shaft.

c. Feeding fuel into the other of the two shafts. The other of the two shafts means the shaft which in step a. is not operated as calcining shaft, preferably the shaft which before the switchover was operated as regenerative shaft.

According to a finding by the inventors, a reduction in the speed of the high-pressure fan by not more than 50% to 65% is already sufficient for the switchover procedure between the operation of a shaft as calcining shaft and as regenerative shaft to be carried out without causing positive-pressure-induced damage to the parallel-flow regenerative shaft kiln. Steps a. and b. are preferably carried out approximately simultaneously.

The shutoff facility comprises, for example, a flap or a valve, the configuration of the shutoff facility being preferably such that in a closed position it reduces or prevents entirely a flow of gas from the respective high-pressure fan into the shaft. In the closed position of the shutoff facility, furthermore, a gas flow between the high-pressure fan and the surroundings is reduced or prevented entirely. During the switchover procedure, preferably, no depressurizing facilities, such as flaps or valves, in the combustion air conduits and/or cooling air conduits to the shaft are opened in order to let off combustion air or cooling air to the surroundings. As a result, the emission of lime dust to the ambient air is prevented.

The closing of the shutoff facility enables a rapid and efficient reduction in pressure within the shaft, thereby enabling a rapid switchover between operation of the shaft as calcining shaft and the regenerative shaft. The shutoff facility is preferably closed in such a way that the gas flow introduced into the shaft by means of the high-pressure fans is reduced by at least about 50% to 65%.

The reduction in the speed of the high-pressure fans in method step b. takes place preferably over a time interval of about 10 to 30 seconds, more particularly 20 seconds. Following the time interval, the high-pressure fan is preferably operated with the reduced speed.

The closing of the shutoff facility in method step b. takes place preferably over a period of about 1 to 5 seconds, more particularly 3 seconds. The speed of high-pressure fans is preferably not reduced or reduced only slightly, such as by about 10% to 30%, on the closing of the shutoff facilities.

According to a further embodiment, for the switchover between the operation of a shaft as calcining shaft and the operation of the shaft as regenerative shaft, at least the following method steps take place:
a. ending the feeding of fuel into the shaft operated as calcining shaft,
b. reducing the gas quantity to the high-pressure fan by means of a swirl regulator disposed in the respective high-pressure fan,
c. closing a shutoff facility between the high-pressure fan and the shaft, so that less of or none of the gas flow compressed by means of the respective high-pressure fan enters the shaft,
d. opening a drain valve disposed downstream of the high-pressure fan to let the gas compressed by means of the high-pressure fan out of the conduit, and
e. feeding fuel into the other of the two shafts.

Upstream of the high-pressure fan in the flow direction of the gas there is preferably a flow rate-measuring facility disposed for ascertaining the amount of gas, more particularly air, that flows through the conduit into the high-pressure fan per unit time. The high-pressure fan preferably has a swirl regulator which is configured to regulate the swirl of the gas flow and is disposed in particular at the gas inlet of the high-pressure fan. The swirl regulator has, for example, a plurality of guide vanes, through which the gas flow passes. The work angles of the guide vanes are preferably adjustable, allowing the swirl of the gas flow entering the high-pressure fan to be adjusted by means of a change to the work angle of the guide vanes.

Disposed downstream of the high-pressure fan there is preferably a pressure-measuring facility configured for ascertaining the pressure within the conduit downstream of the high-pressure fan. Mounted downstream of the high-pressure fan is, for example, a drain valve, which in an opened position enables a flow of gas from the conduit into the surroundings, for example, and in a closed position does not permit any flow of gas from the conduit. The drain valve is disposed, for example, upstream of the pressure-measuring facility. Disposed downstream of the pressure-measuring facility in the flow direction of the gas, preferably, is a shutoff facility as already described above.

In the step b, the quantity of gas is reduced by at least 50% to 65%, for example. The quantity of gas is reduced preferably by means of the swirl regulator, more particularly via a change to the work angles of the guide vanes of the swirl regulator. During the switching procedure, the speed of the high-pressure fan is preferably held substantially constant or reduced only slightly, more particularly by not more than 10% to 30%.

The quantity of gas which flows through the conduit into the high-pressure fan is preferably ascertained by means of the flow rate-measuring facility. The opening width of the drain valve is preferably steplessly adjustable. The opening width of the drain valve and/or the swirl regulator are/is preferably adjusted as a function of the quantity of gas ascertained by means of the flow rate-measuring facility. A target value for the quantity of gas is preferably determined beforehand.

If the value ascertained for the quantity of gas exceeds the predetermined target, the swirl regulator, for example, more particularly the work angle of the guide vanes, is adjusted in such a way that the quantity of gas entering the high-pressure fan is reduced. If the value ascertained for the quantity of gas falls below the predetermined target, the swirl regulator, for example, more particularly the work angle of the guide vanes, is adjusted in such a way that the quantity of gas entering the high-pressure fan is increased.

If the value ascertained for the quantity of gas exceeds the predetermined target, the opening width of the drain valve is preferably increased. If the value ascertained for the quantity of gas falls below the predetermined target, the opening width of the drain valve is reduced.

The connection described offers the advantage that there is no need to reduce the speed of the high-pressure fan. Instead, the quantity of air to the high-pressure fan is reduced, and is preferably reduced to a minimum. A substantially constant speed of the high-pressure fan reliably prevents speed-fluctuation-induced mechanical loads on the high-pressure fan.

According to a further embodiment, following or simultaneous with the step b), an increase is carried out in the speed of an off-gas fan for conveying the off-gas from the parallel-flow regenerative shaft kiln, and so the quantity of off-gas removed from the shaft, more particularly from the regenerative shaft, is increased and preferably the outward flow of off-gas from the shaft is made easier. This ensures a rapid pressure drop within the shafts of the PFR kiln. The speed of the off-gas fans is increased for example by about 5% to 30%, more particularly 15%.

According to a further embodiment, following step b and/or following the increasing of the speed of the off-gas fan, the off-gas shutoff facility in the off-gas conduit is opened for conducting off-gases out of the shaft operated as calcining shaft. Preferably each shaft has an off-gas outlet which is connected to an off-gas conduit and to the fan. Preferably each off-gas outlet is assigned an off-gas shutoff facility, such as a flap or a valve, for example, which is mounted preferably in the off-gas conduit and which in the closed position prevents any flowing of off-gas from the respective shaft into the off-gas conduit, and permits such flowing in the opened position. In the operation, more particularly in calcining operation, of the PFR shaft kiln, it is preferable for only the off-gas shutoff facility which is assigned to the off-gas outlet of the shaft operated as regenerative shaft to be opened. On switchover, preferably, the off-gas shutoff facility which is assigned to the off-gas outlet of the shaft operated as calcining shaft is opened additionally. For the switchover, preferably, all of the off-gas shutoff facilities of the off-gas conduit are opened. This additionally ensures a rapid loss of pressure within the calcining shaft. The off-gas shutoff facility is opened more particularly as soon as the pressure within the shaft, more particularly within the calcining shaft, has fallen below a predetermined limit. The limit is, for example, about 100 mbar to 300 mbar, preferably 200 mbar.

According to a further embodiment, the calcined material is discharged from the parallel-flow regenerative shaft kiln by a discharge system, wherein the discharge system has a product outlet and, downstream thereof, a buffer store with a further product outlet, and wherein the material is discharged continuously from the parallel-flow regenerative shaft kiln during the operation of a shaft as calcining shaft, and there is no discharge of material from the parallel-flow regenerative shaft kiln during the switchover between the operation of a shaft as calcining shaft and the operation of the shaft as regenerative shaft. For example, step a. comprises the closing of the discharge system, more particularly of at least one or all of the product outlets of the discharge system.

According to a further embodiment, the pressure within the shaft is ascertained and the product outlet for letting calcined material out of the shaft operated as calcining shaft is opened if the pressure has fallen below a predetermined limit. This prevents any positive-pressure-induced emergence of lime dust into the surroundings through the product outlet. The pressure within the calcining shaft is preferably ascertained. The limit is, for example, 20 mbar. Optionally, following step b and before step c., the product outlet is opened for letting material out of the shaft operated as calcining shaft, and so the calcined material is removed from the calcining shaft. The product outlet comprises, for example, flaps, which may be opened and closed, preferably steplessly, and in particular automatically or manually. Following, preferably simultaneously with or before step c, the product outlet is closed again, preferably after a predetermined time interval. After that, the operation of the shaft is reversed, with fuel and combustion air being introduced into the former regenerative shaft.

It is likewise conceivable for a depressurization facility, such as a valve or a flap for letting the gas flow out to the surroundings, for example, to be opened within the combustion air conduit and/or the cooling air conduit if the pressure ascertained exceeds a defined limit. The depressurization facility is preferably opened following step b, more particularly following the reducing of the speed of the high-pressure fan or the closing of the shutoff facility. The limit is, for example, around 100 mbar to 300 mbar, preferably 200 mbar. The depressurization facility preferably has a closed position, in which it allows a flow of gas from the fan into the shaft, and an open position, in which it prevents a flow of gas between the fan and the shaft and allows a flow of gas from the fan out of the respective conduit into the surroundings.

The method for calcining and cooling material in a parallel-flow regenerative shaft kiln, more particularly the switchover between the operation of a shaft as calcining shaft and the operation of the shaft as regenerative shaft, embraces a multiplicity of variants which have been described above. Set out illustratively below in summary are at least three variants for the switchover of operation:

A first variant for the switchover of operation comprises:
a. ending the feeding of fuel into the shaft operated as calcining shaft, and simultaneously
b. reducing the speed of the high-pressure fan by not more than 50% to 65%, and/or closing a shutoff facility between the high-pressure fan and the kiln, so that less or none of the gas flow compressed by means of the respective high-pressure fan flows into the shaft, and so the positive pressure in the kiln drops, and
c. opening the off-gas shutoff facility assigned to the calcining shaft if the pressure in the calcining shaft has fallen below 200 mbar, preferably in order to drain off the residual positive pressure in the kiln in the direction of the off-gas filter, and subsequently
d. opening and closing the product outlet to let material out of the calcining shaft, and subsequently
e. feeding oxidizing gas into the one which is operated subsequently as the calcining shaft,
f. closing the off-gas shutoff facility on the kiln shaft which is operated subsequently as the calcining shaft, and subsequently
g. opening the shutoff facilities between the high-pressure fans and the kiln and increasing the speed of the high-pressure fans, so that the gases required for combustion and cooling are again available in the correct quantity, and
h. feeding fuel into the calcining shaft.

Another variant differs from the described first variant in that step c is replaced by the opening of the depressurization facilities in the combustion air and/or the cooling air conduit if the pressure in the shaft falls below a value of 200 mbar, in order to drain off the residual positive pressure in the shaft into the surroundings.

Another variant differs from the described first variant in that step d is omitted, with step a comprising the closing of the discharge system and the discharge system being opened again simultaneously with or following step h.

The invention further embraces a parallel-flow regenerative shaft kiln for calcining and cooling material, such as carbonate rocks, having two shafts, which can be operated alternately as calcining shaft and as regenerative shaft, wherein each shaft in the flow direction of the material has a preheating zone for preheating the material, a calcining zone for calcining the material, and a cooling zone for cooling the material, the PFR shaft kiln having at least one high-pressure fan which is configured and disposed for compressing a gas flow introduced into the PFR shaft kiln.

The advantages and embodiments described above in reference to the method for calcining and cooling material, such as carbonate rocks, in a parallel-flow regenerative shaft kiln are likewise applicable, in apparative correspondence, to the parallel-flow regenerative shaft kiln.

The parallel-flow regenerative shaft kiln according to one embodiment has a combustion air inlet for letting combustion air and/or a fuel gas into the preheating zone and/or the calcining zone, and a cooling air inlet for letting cooling air into the cooling zone, wherein the combustion air inlet and/or the cooling air inlet are connected to respectively one high-pressure fan, more particularly in such a way that the high-pressure compressor compresses the cooling air and the combustion air. Furthermore, the PFR shaft kiln preferably has a cooling air circuit line for conducting cooling air through the lower part of the refractory lining of the calcining zone, the cooling air circuit line being connected to a fan.

According to a further embodiment, the parallel-flow regenerative shaft kiln has an open-loop/closed-loop controller which is connected to a fuel inlet for letting fuel gas into the shaft and is configured in such a way that it provides for an operating state for the switchover between the operation of a shaft as calcining shaft and the operation of the shaft as regenerative shaft, and stops the fuel gas feed through the fuel inlet in this operating state.

The fuel inlet is formed preferably by the burner lances or the combustion air inlet. The fuel gas feed is adjusted preferably via metering facilities connected to the fuel inlet, such as flaps or valves. The open-loop/closed-loop controller is preferably connected to the metering facilities for adjusting the fuel gas feed into the shaft.

According to a further embodiment, the open-loop/closed-loop controller is connected to the high-pressure fan and is configured in such a way that in the switchover operating state it reduces the speed of the high-pressure fan by not more than 50% to 65%.

According to a further embodiment, each shaft has an off-gas outlet for letting off-gases out of the respective shaft, wherein the off-gas outlet is connected to a fan and wherein the open-loop/closed-loop controller is configured in such a way that in the switchover operating state it increases the speed of the fan.

The speed of the fan in the off-gas conduit is increased preferably following or simultaneously with the reduction in the speed of the high-pressure fan. The fan is configured for example as a low-pressure or medium-pressure fan, and so it generates in particular a pressure of about 20 mbar to 40 mbar, preferably 30 mbar. Furthermore, the off-gas outlet is connected preferably to an off-gas filter, disposed upstream of the fan, for filtering dust out of the off-gas.

According to a further embodiment, each off-gas outlet is connected via an off-gas conduit to the fan, wherein at least one off-gas shutoff facility is disposed in the off-gas conduit and is connected to the open-loop/closed-loop controller, and wherein the open-loop/closed-loop controller is configured in such a way that in the switchover operating state it opens the off-gas shutoff facility following the increasing of the speed of the fan. The off-gas shutoff facility is connected more particularly to the open-loop/closed-loop controller in such a way that this controller opens the off-gas shutoff facility if the pressure within the shaft, more particularly the calcining shaft, as ascertained by means of the pressure-measuring facility, has fallen below a predetermined limit. The limit is, for example, around about 100 mbar to 300 mbar, preferably 200 mbar.

According to a further embodiment, each shaft has a product outlet for letting calcined material out of the respective shaft, and a pressure-measuring facility for ascertaining the pressure within the shaft, wherein the open-loop/closed-loop controller is connected to the product outlet and to the pressure-measuring facility and is configured in such a way that it opens the product outlet if the pressure ascertained falls below a predetermined limit.

According to a further embodiment, each shaft has a discharge system with a product outlet for letting calcined material out of the respective shaft and with a buffer store downstream of the product outlet and having a further product outlet.

The discharge system preferably has two product outlets which are disposed in series and are configured, for example, as flaps, with a buffer store being disposed between the product outlets. This airlock-type product outlet allows material to be discharged from the respective shaft when there is a positive pressure in the kiln shafts, without lime dust entering the surroundings. Downstream of the discharge systems of the two shafts there is also, preferably, a bunker for accommodating the material.

According to a further embodiment, each high-pressure fan is assigned a shutoff facility which in a closed position prevents any flow of gas from the respective high-pressure fan into the shaft, and wherein the open-loop/closed-loop controller is connected to the shutoff facility and is configured in such a way that in the switchover operating state it moves the shutoff facility into the closed position.

The shutoff facility is preferably closed following or simultaneously with the reducing of the speed of the high-pressure fan. The shutoff facility is, for example, a flap or a valve and is preferably configured in such a way that in a closed position it prevents any flow of gas from the respective fan, more particularly the high-pressure fan, into the shaft. The combustion air conduit and the cooling air conduits preferably each have a shutoff facility, which is downstream of the respective fan. In the closed position of the shutoff facility, the latter preferably prevents any flow of gas out of the respective conduit into the surroundings.

### DESCRIPTION OF THE DRAWINGS

The invention is elucidated in more detail below by means of a number of exemplary embodiments with reference to the appended figures.

FIG. 1 shows a schematic representation of a PFR shaft kiln in a sectional view according to one exemplary embodiment.

FIG. 1a shows a schematic representation of the detail A of FIG. 1 according to one exemplary embodiment.

FIG. 2 shows a schematic representation of a PFR shaft kiln in sectional view according to a further exemplary embodiment.

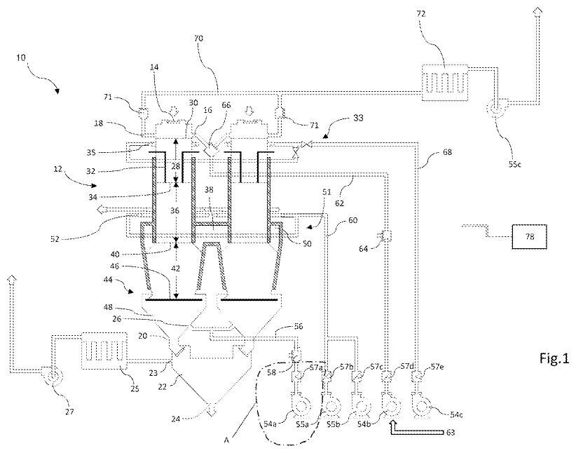

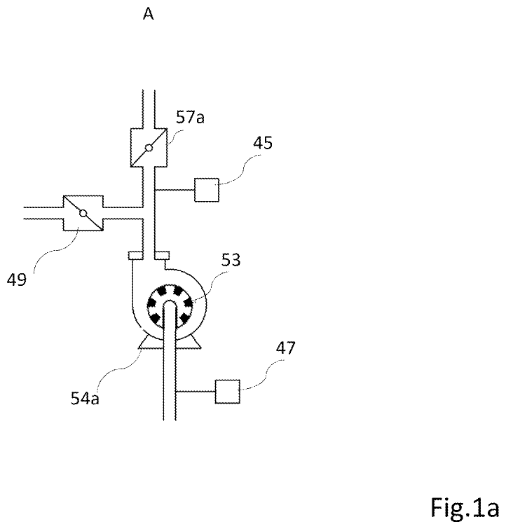

FIG. 1 shows a PFR shaft kiln 10 having two parallel and vertically oriented shafts 12. The shafts 12 of the PFR shaft kiln 10 are substantially identical in construction, and accordingly in FIG. 1 only one of the two shafts 12 is provided with reference symbols and, for the sake of simplicity, only one of the two shafts is described hereinafter. Each shaft 12 has a respective materials inlet 14 for letting material for calcining into the respective shaft 12 of the PFR shaft kiln. The material for calcining is more particularly limestone. The materials inlets 14 are disposed, illustratively, at the upper end of the respective shaft 12, and so the material falls through the materials inlet 14 by gravity into the shaft 12.

Each shaft 12 at its upper end also has a combustion air inlet 16 for letting combustion air or fuel gas in. The combustion air is, for example, air, oxygen-enriched air or pure oxygen. The fuel gas is, for example, blast-furnace gas or another fuel gas having a calorific value of less than 6.6 MJ/Nm³. Furthermore, each shaft 12 has an off-gas outlet 18 for letting kiln off-gases out of the respective shaft 12.

At the lower end of each shaft 12 there is a product outlet 20 for letting out the material calcined in the respective shaft 12. The product outlet 20 comprises, for example, flaps, which can be opened and closed automatically in particular. The calcined material is conducted for example into a bunker 22 which follows on from the product outlets 20 of the shafts 12. The bunker 22 is configured illustratively in the form of a hopper and has, illustratively, a bunker outlet 24 for letting the material out of the bunker 22. The bunker, furthermore, has an outgoing-air outlet 23 for letting outgoing air out of the bunker 22. The outgoing-air outlet 23 is followed by an outgoing-air filter 25 and a low-pressure fan 27 for dedusting the off-gas.

Each shaft 12 at its lower end has a cooling air inlet 26 for letting cooling air into the respective shaft 12. In the operation of the PFR shaft kiln 10, the material for calcining flows from top to bottom through the respective shaft 12, with the cooling air flowing through the respective shaft 12 from bottom to top, in countercurrent flow to the material. The kiln off-gas is removed from the shaft 12 through the off-gas outlet 18.

The materials inlet 14 and the combustion air inlet 16 are followed below them, in the flow direction of the material, by the preheating zone 28 of the respective shaft 12. In the preheating zone 28, the material and the combustion air or, optionally, the material and the fuel gas are preheated preferably to about 700° C. The respective shaft 12 is preferably filled with material for calcining up to the upper boundary face 30 of the preheating zone 28. The material and optionally the fuel, more particularly the fuel gas, are charged into the respective shaft 12 preferably above the preheating zone 28. At least part of the preheating zone 28, and the part of the respective shaft 12 that follows it in the flow direction of the material, are surrounded, for example with a refractory lining.

Disposed optionally in the preheating zone 28 are a plurality of burner lances 32, serving in each case as an inlet for fuel, such as a fuel gas, oil or ground solid fuel, for example. The PFR shaft kiln 10 preferably has a cooling facility 33 for cooling the burner lances. The cooling facility comprises a plurality of cooling-air circuit lines 35, which extend annularly around the shaft region in which the burner lances 32 are disposed. Cooling air for cooling the burner lances 32 flows through the cooling-air circuit lines 35.

In each shaft 12 there are preferably a plurality of—for example, twelve—burner lances 32, which are disposed at substantially uniform distances from one another. The burner lances 32 have an L shape, for example, and extend preferably in the horizontal direction into the respective shaft 12 and in a vertical direction within the shaft 12, more particularly in the flow direction of the material. The ends of the burner lances 32 of one shaft 12 are preferably all disposed at the same height level. The plane on which the ends of the lances 32 are disposed is preferably in each case the lower boundary face 34 of the respective preheating zone 32, 34. Alternatively or additionally to the burner lances 32, slits in the shaft wall may also form inlets for letting combustion air into the shaft.

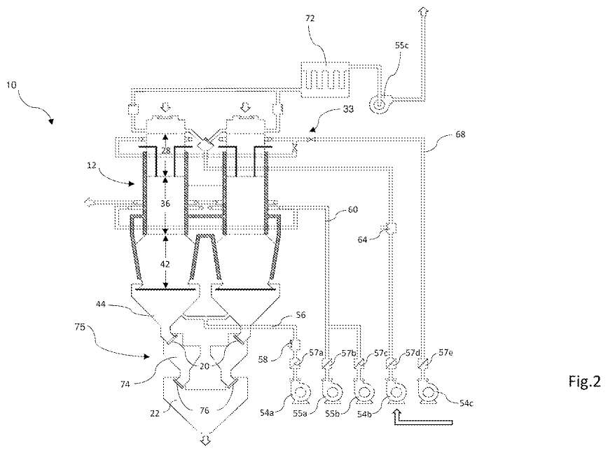

The preheating zone 28 is followed in the flow direction of the material by the calcining zone 36. In the calcining zone 36, the fuel is burned and the preheated material is calcined at a temperature of about 1000° C. The PFR shaft kiln 10 additionally has an overflow duct 38 for providing a gas connection between the two shafts 12. FIGS. 1 and 2 show, illustratively, a PFR lime kiln having round shaft cross sections. The shaft cross section may, however, have a different geometrical contour. Depending on the cross-sectional shape used for the shafts, there are gas collector ducts 50 which are connected to the overflow duct 38. Also possible are shaft cross sections for which there is no need for the additional gas collector ducts 50. Disposed at the upper height level of the overflow duct 38, preferably, is the lower boundary face 40 of the calcining zone 36, more particularly the end of the calcining zone 36. The calcining zone 36 is followed in the flow direction of the material in each shaft 12 by a cooling zone 42, which extends down to the product outlet 20 or to the discharge facility of the respective shaft. The material is cooled within the cooling zone 42 to about 100° C.

At the product outlet end of each shaft 12 there is preferably a discharge facility 44 disposed. The discharge facilities 44 comprise, for example, horizontal plates, preferably a discharge table 46, which allow the material to pass through laterally between the discharge table 46 and the housing wall of the PFR shaft kiln. The discharge facility 44 is implemented preferably as a push table or rotary table or as a table with push-type scraper means. This enables a uniform throughput rate of the calcination material through the shafts 12. The discharge facility 44 further comprises, illustratively, a discharge hopper 48, which follows the discharge table and has the product outlet 20 mounted on its lower end.

In the operation of the PFR shaft kiln 10, one of the shafts 12 is active in each case, with the respective other shaft 12 being passive. The active shaft 12 is referred to as the calcining shaft, and the passive shaft 12 as the regenerative shaft. The PFR shaft kiln 10 is operated cyclically; a typical number of cycles is, for example, 75 to 150 cycles per day. After the cycle time has expired, the function of the shafts 12 is swapped. This procedure is repeated continuously.

Material such as limestone or dolomite rock is charged into the shafts 12 in alternation via the materials inlets 14. In the shaft 12 operated as calcining shaft, a fuel or an oxidizing gas such as, for example, air, oxygen-enriched air or pure oxygen is introduced into the calcining shaft via the burner lances 32. The material for calcining is heated in the preheating zone 28 of the calcining shaft to a temperature of about 700° C.

The PFR shaft kiln 10 has, for example, a round, oval, rectangular or polygonal cross section. Furthermore, the PFR shaft kiln 10 optionally has a gas collector duct 50 in the form of an annular space. The gas collector duct 50 extends preferably circumferentially around the lower region of the calcining zone 36, more particularly below the burner lances 32. Each shaft 12 may have a respective gas collector duct 50, with the gas collector ducts 50 being disposed at the height level of the overflow duct 38 for connection of the two shafts 12. The gas collector ducts 50 of the two shafts 12 have a gas connection to one another by way in particular of the overflow duct 38. In particular, the gas collector duct 50 has a gas connection to the cooling zone 42, and so the cooling gas flows at least partly into the gas collector duct 50.

This construction leads advantageously to a more uniform distribution of gas and of temperature in the shafts 12 and hence to better product quality and lower pollutant emissions. Another advantage of this construction is that any unburned fuel gases which flow out of the preheating zone 28 into the overflow channel 38, together with the cooling air fed to the calcining shaft, undergo afterburning there more effectively, because the gas duct volume is substantially greater.

The PFR shaft kiln further comprises, preferably, a cooling facility 51 for cooling the shaft region which includes the calcining zone 36. In particular, the region of the calcining zone 36 that projects into the cooling zone 42 is cooled by means of the cooling facility 51. The cooling facility 51 preferably comprises a plurality of circuit lines 52, which extend externally around the calcining zone of the shaft 12 and through which cooling air flows. Illustratively, the circuit lines 52 are mounted only around the lower region—the region adjacent to the cooling zone 42—of the calcining zone 36.

The combustion air inlet 16, the cooling air inlet 26, the burner lances 32, and the cooling-air circuit lines 35, 52 are each connected via conduits to a fan 55a,b, more particularly a high-pressure fan 54a-c. The high-pressure fans 54a-c serve to compress the respective process gases and are preferably configured in such a way that they each generate a pressure of about 300 mbar to 500 mbar, more particularly about 400 mbar. Each fan 55a-c, and each high-pressure fan 54a-c, is preferably assigned a shutoff facility 57a-e. The shutoff facility is, for example, a flap or a valve and is preferably configured in such a way that in a closed position it prevents a flow of gas from the respective fan 54a-c, 55a-c, more particularly from the high-pressure fan 54a-c, into the shaft 12. The combustion air conduit 62 and the cooling air conduits 56, 60, 68 preferably each have a shutoff facility 57a-e which is downstream of the respective fan 54a-c, 55a-c. In the closed position of the shutoff facility 57, there is preferably no possibility of a flow of gas from the respective conduit 56, 60, 62, 68 into the surroundings.

The cooling air inlet 26, for letting cooling air into the cooling zone 42, is connected more particularly to a high-pressure fan 54a via a cooling air conduit 56. The cooling air conduit 56 comprises a depressurization facility 58, such as a valve or a flap, for example, which can be brought, preferably steplessly, from an open position, in which cooling air flows from the cooling air conduit 56 into the surroundings, into a closed position, in which no cooling air emerges from the cooling air conduit 56.

The cooling facility 51 for cooling the shaft region which includes the calcining zone is connected, preferably via a cooling air conduit 60, to a fan 55a and optionally to a further fan 55b. The fans 55a, b are configured for example as medium-pressure or high-pressure fans, and so they generate in particular a pressure of about 50 mbar to 150 mbar, preferably 80 mbar to 120 mbar, more particularly 100 mbar.

The combustion air inlet 16, for letting combustion air into the preheating zone 28, is connected more particularly to a high-pressure fan 54b via a combustion air conduit 62. The combustion air conduit 62 comprises a depressurization facility 64, such as a valve or a flap, for example, which can be brought preferably steplessly from an open position, in which combustion air flows from the combustion air conduit 62 into the surroundings, into a closed position, in which no combustion air emerges from the combustion air conduit 62. Combustion air conduit 62 further preferably comprises a distributor facility 66, such as, for example, a gas diverter or a flap for conducting the combustion air to the respective shaft 12 operated as calcining shaft. The configuration of the distributor facility 66 is preferably such that it can be operated in at least two position: in a first position, combustion air is able to flow exclusively into the combustion air inlet 16 of the first shaft 12, and, in a second position, combustion air is able to flow exclusively into the combustion air inlet 16 of the second shaft 12.

The cooling facility 33 for cooling the burner lances 32, more particularly the cooling-air circuit line 35, is connected preferably via a cooling air conduit 68 to a high-pressure fan 54c.

The off-gas outlet 18 for letting the kiln off-gases out of the PFR shaft kiln is connected to a fan 55c preferably via an off-gas conduit 70. The fan 55c is configured, for example, for medium pressure, and so it generates in particular a pressure of about 20 mbar to 60 mbar, preferably 25 mbar to 50 mbar, more particularly 35 mbar. Furthermore, the off-gas outlet 18 is connected preferably to an off-gas filter 72 disposed upstream of the fan 55c. The off-gas conduit 70 additionally has, illustratively, two off-gas shutoff facilities 71, more particularly valves or flaps. In the flow direction of the off-gas, downstream of each off-gas outlet 18, there is preferably a respective off-gas shutoff facility 71 disposed, and so each off-gas outlet is preferably assigned an off-gas shutoff facility 71. The off-gas shutoff facility 71 can be moved between a closed position, in which no off-gas can flow from the shaft 12 through the off-gas conduit 70, and an open position, in which off-gas can flow through the off-gas conduit 70.

Optionally it is conceivable to charge the fuel, more particularly the fuel gas, into the calcining shaft of the PFR shaft kiln 10 by way of the combustion air inlet 16. In this embodiment of the PFR shaft kiln, the fuel gas is more particularly blast-furnace gas, having for example a calorific value of less than 6.6 MJ/Nm³. The fuel gas 63, more particularly the blast-furnace gas, is introduced in this embodiment into the combustion air conduit 62, and the combustion air is guided in particular through the burner lances into the shaft 12. The combustion air is, for example, oxygen-containing air, more particularly oxygen-enriched air, or a gas having an oxygen fraction of about 80%, or virtually pure oxygen.

This method reduces the quantities of gas which flow through the calcining zone 36 and through the preheating zone 28 of the regenerative shaft considerably; the gases flowing through the preheating zone 28 of the regenerative shaft contain no excess heat and preferably have an off-gas temperature of around 100° C. Owing to the smaller quantities of gas there is a considerable reduction in the pressure loss of the kiln as a whole, leading to a considerable saving in terms of electrical energy at the process gas compressors.

FIG. 1a shows the detail A marked in FIG. 1. The detail A shows, illustratively, the high-pressure fan 54a; the connection system represented can be employed for all other high-pressure fans 54a-c. Upstream of the high-pressure fan 54a in the flow direction of the gas is a flow rate-measuring facility 47 for ascertaining the quantity of gas, more particularly air, that flows per unit time through the conduit into the high-pressure fan 54a. The high-pressure fan 54a has a swirl regulator 53 which is configured to regulate the swirl of the flow of gas and is disposed at the gas inlet of the high-pressure fan 54a. The swirl regulator 53 comprises, for example, a plurality of guide vanes through which the gas flow flows. The work angles of the guide vanes are preferably adjustable, and so the swirl of the flow of gas entering the high-pressure fan 54a can be adjusted by means of a change to the work angle of the guide vanes.

FIG. 1a additionally shows a pressure-measuring facility 45 which is disposed downstream of the high-pressure fan 54a and is configured for determining the pressure within the conduit downstream of the high-pressure fan 54a. Mounted downstream of the high-pressure fan 54a, illustratively, is a drain valve 49, which in an open position enables a flow of gas from the conduit, for example, into the surroundings, and in a closed position does not allow any flow of gas from the conduit. The drain valve 49 is disposed, illustratively, upstream of the pressure-measuring facility. Downstream of the pressure-measuring facility 45 in the flow direction of the gas there is a shutoff facility 57a disposed, which has already been described above.

FIG. 2 represents a further embodiment of the PFR shaft kiln, which corresponds substantially to the PFR shaft kiln 10 of FIG. 1, with the difference that the calcined material is discharged in stages. The PFR shaft kiln 10 of FIG. 2 has a discharge system 73 which includes a product outlet 20, as described with reference to FIG. 1. In addition, the product outlet 20 is followed, and the bunker 22 preceded, by a buffer store 74 having a further product outlet 76 for letting the material out of the buffer store 74 into the bunker 22. The product outlet 76 is identical in configuration, for example, to the above-described product outlet 20. The materials discharge system 75 of FIG. 2 enables the discharge of material from the PFR shaft kiln 10 while a positive pressure is prevailing in the calcining shaft. As a result there is no need for a complete reduction of pressure in the switchover procedure wherein the function of the calcining shaft and of the regenerative shaft is swapped.

The PFR shaft kiln 10 of FIGS. 1 and 2 preferably also has an open-loop/closed-loop controller 78, which is connected preferably to the high-pressure fans 54a-c and the fans 55a-c for the open-loop/closed-loop control of the speed. The open-loop/closed-loop controller 78 is preferably further connected to a pressure-measuring facility, not represented in the figures, and so the pressure-measuring facility disposed in the shaft 12 transmits the ascertained pressure within the shaft 12 to the open-loop/closed-loop controller 78. The open-loop/closed-loop controller 78 is connected, furthermore, in particular to at least one or all of the shutoff facilities 57a-e, which accordingly can be opened and closed by means of the open-loop/closed-loop controller 78. The open-loop/closed-loop controller 78 is connected preferably to the product outlet 20, 76 in such a way that said outlet opens or closes depending, for example, on the pressure ascertained within the shaft 12, more particularly within the calcining shaft.

In the operation of the PFR shaft kiln 10 represented in FIGS. 1 and 2, for the switchover between the operation of a shaft 12 as calcining shaft and the operation of the shaft 12 as regenerative shaft, at least the following method steps are carried out:
a. ending the feeding of fuel into the shaft 12 operated as calcining shaft,
b. reducing the speed of the high-pressure fan 54a-c by not more than 50% to 65%, and/or closing a shutoff facility 57a-e between the high-pressure fan 54a-c and the shaft 12, and so no gas flow compressed by means of the respective high-pressure fan enters the shaft 12, and
c. when a residual positive pressure of, for example, less than 200 mbar has been reached, opening the off-gas shutoff facility 71 on the kiln shaft which has just been the calcining shaft, in order to drain off the residual positive pressure in the kiln in the direction of the off-gas filter, and
d. opening and closing the product outlet 20 to let material out of the kiln, and subsequently
e. changing over the distributor facility 66 in order to feed the oxidizing gas or the fuel gas to the shaft which is subsequently operated as calcining shaft, and
f. closing the off-gas shutoff facility 71 on the kiln shaft which is operated subsequently as the calcining shaft, and subsequently
g. opening the shutoff facilities 57a-e between the high-pressure fans and the kiln and increasing the speed of the high-pressure fans 54a-c, so that the gases required for combustion and cooling are again available in the correct quantity, and subsequently
h. engaging the fuel on the calcining shaft 12.

The open-loop/closed-loop controller 78 is preferably configured to provide open-loop/closed-loop control of the method steps described above.

In the case of a connection system of the high-pressure fans 57a-c as represented in FIG. 1a, the following steps preferably take place:
a. ending the feeding of fuel into the shaft 12 operated as calcining shaft,
b. reducing the quantity of gas to the high-pressure fan 54a-c by means of the swirl regulator 53 of the respective high-pressure fan 54a-c,
c. closing a shutoff facility 57a-e between the high-pressure fan 54a-c and the shaft 12, so that there is no gas flow compressed by means of the respective high-pressure fan 54a-c into the shaft 12,
d. opening the drain valve 49 to let the gas compressed by means of the high-pressure fan 54a-c out of the conduit,
c. when a residual positive pressure within the kiln shaft of, for example, less than 200 mbar has been reached, opening the off-gas shutoff facility 71 on the kiln shaft which has just been the calcining shaft, in order to drain off the residual positive pressure in the kiln in the direction of the off-gas filter, and
d. opening and closing the product outlet 20 to let material out of the kiln, and subsequently
e. changing over the distributor facility 66 in order to feed the oxidizing gas or the fuel gas to the shaft which is subsequently operated as calcining shaft, and
f. closing the off-gas shutoff facility 71 on the kiln shaft which is operated subsequently as the calcining shaft, and subsequently
g. opening the shutoff facilities 57a-e between the high-pressure fans and the kiln and also increasing the quantity of gas to the high-pressure fan 54a-c by means of the swirl regulator 53 of the respective high-pressure fan 54a-c, so that the gases needed for combustion and cooling are available again in the amount necessary for operation of the kiln, and subsequently
h. engaging the fuel on the calcining shaft 12.

In step b the quantity of gas is reduced by—for example—at least 50% to 65%. The quantity of gas is reduced by means of the swirl regulator 53, more particularly by way of a change to the work angles of the guide vanes of the swirl regulator 53. During the switchover procedure, the speed of the high-pressure fan 54a-c is preferably kept substantially constant or is reduced only slightly, more particularly by not more than 10% to 30%.

The quantity of gas which flows through the conduit into the high-pressure fan 54a-c is preferably ascertained by means of the flow rate-measuring facility 47. The opening width of the drain valve 49 is preferably steplessly adjustable. The opening width of the drain valve 49 and/or the swirl regulator 53 are/is preferably adjusted as a function of the quantity of gas ascertained by means of the flow rate-measuring facility 47. A target value for the quantity of gas is preferably determined beforehand.

If the figure ascertained for the quantity of gas exceeds the predetermined target value, then for example the swirl regulator 53 is adjusted, and more particularly the work angle of the guide vanes is adjusted, in such a way that the quantity of gas entering the high-pressure fan 54a-c is reduced. If the value ascertained for the quantity of gas falls below the predetermined target value, then for example the swirl regulator 53, and more particularly the work angle of the guide vanes, is adjusted in such a way that the quantity of gas entering the high-pressure fan 54a-c is increased.

If the value ascertained for the quantity of gas exceeds the predetermined target value, the opening width of the drain valve 49 is preferably increased. If the value ascertained for the quantity of gas falls below the predetermined target value, the opening width of the drain valve 49 is reduced.

The connection system represented in FIG. 1 offers the advantage that there is no need to reduce the speed of the high-pressure fan 54a-c. Instead, the quantity of air to the high-pressure fan 54a-c is reduced, and is preferably reduced to a minimum. A substantially constant speed of the high-pressure fan reliably prevents speed-fluctuation-related mechanical loads on the high-pressure fan.

### LIST OF REFERENCE SYMBOLS

10 PFR shaft kiln
12 shaft
14 materials inlet for letting in limestone
16 combustion air inlet
18 off-gas outlet
20 product outlet
22 bunker
23 outgoing-air outlet
24 bunker outlet
25 outgoing-air filter
26 cooling air inlet
27 low-pressure fan
28 preheating zone
30 upper boundary face of the preheating zone
32 burner lances
33 cooling facility
34 lower boundary face of the preheating zone/upper boundary face of the calcining zone
35 cooling-air circuit lines
36 calcining zone
38 overflow duct
40 lower boundary face of the calcining zone/upper boundary face of the cooling zone
42 cooling zone
44 discharge facility
45 pressure-measuring facility
46 discharge table
47 flow rate-measuring facility
48 discharge hopper
49 drain valve
50 gas collector duct
51 cooling facility
52 cooling-air circuit lines
53 swirl regulator
54a-c high-pressure fan
55a-c fan
56 cooling air conduit
57a-e shutoff facility
58 depressurization facility
60 cooling air conduit
62 combustion air conduit
63 fuel gas
64 depressurization facility
66 distributor facility
68 cooling air conduit
70 off-gas conduit
71 off-gas shutoff facility
72 off-gas filter
74 buffer store
75 discharge system
76 product outlet
78 open-loop/closed-loop controller

1.-17. (canceled)

18. A method for calcining and cooling material in a parallel-flow regenerative shaft kiln that has two shafts that are operated alternately as a calcining shaft and as a regenerative shaft, the method comprising:
causing the material to flow through a preheating zone, a calcining zone, and a cooling zone to a product outlet; and
compressing a gas flow with a high-pressure fan and introducing the gas flow into the parallel-flow regenerative shaft kiln, wherein the high-pressure fan is an axial fan or a radial fan that has an impeller through which flow takes place axially or radially.

19. The method of claim 18 wherein the gas flow comprises:
a cooling air flow that is introduced into the cooling zone;
a combustion air flow that is introduced into the preheating zone and/or the calcining zone; and/or
a fuel gas flow that is introduced into the preheating zone and/or the calcining zone.

20. The method of claim 18 wherein for switchover between the operation of a first shaft as the calcining shaft and as the regenerative shaft, the method comprises:
ending feeding of fuel into the first shaft operated as the calcining shaft;
reducing a gas quantity to the high-pressure fan with a swirl regulator disposed in the high-pressure fan;
closing a shutoff facility between the high-pressure fan and the first shaft so that less of or none of the gas flow compressed by the high-pressure fan enters the first shaft;
opening a drain valve disposed downstream of the high-pressure fan to let gas compressed by the high-pressure fan out of a conduit; and
feeding fuel into the a second of the two shafts.

21. The method of claim 18 wherein for switchover between the operation of a first shaft as the calcining shaft and as the regenerative shaft, the method comprises:
ending feeding of fuel into the first shaft operated as the calcining shaft;
reducing a speed of the high-pressure fan by not more than 50% to 65% and/or closing a shutoff facility between the high-pressure fan and the first shaft so that less of or none of the gas flow compressed by the high-pressure fan enters the first shaft; and
feeding fuel into a second of the two shafts.

22. The method of claim 21 wherein simultaneously with or following the step whereby less or none of the gas flow compressed by the high-pressure fan enters the first shaft, the method comprises increasing a speed of an off-gas fan for conveying off-gas out of the parallel-flow regenerative shaft kiln.

23. The method of claim 21 wherein following the step whereby less or none of the gas flow compressed by the high-pressure fan enters the first shaft, the method comprises opening an off-gas shutoff facility in an off-gas conduit to conduct off-gases out of the first shaft operated as the calcining shaft.

24. The method of claim 18 comprising discharging calcined material from the parallel-flow regenerative shaft kiln with a discharge system, wherein the discharge system includes the product outlet and, downstream of the product outlet, a buffer store with a second product outlet, wherein the calcined material is discharged continuously from the parallel-flow regenerative shaft kiln during operation of a shaft as the calcining shaft, wherein there is no discharge of calcined material from the parallel-flow regenerative shaft kiln during switchover between the operation of a first shaft as the calcining shaft and the operation of the first shaft as the regenerative shaft.

25. The method of claim 18 comprising ascertaining a pressure within a first shaft of the two shafts, wherein the product outlet for letting calcined material out of the first shaft operated as calcining shaft is opened if the pressure falls below a predetermined limit.

26. A parallel-flow regenerative shaft kiln for calcining and cooling material, comprising:
two shafts that are operated alternately as a calcining shaft and as a regenerative shaft, wherein each shaft in a flow direction of material has a preheating zone for preheating material, a calcining zone for calcining material, and a cooling zone for cooling material; and
a high-pressure fan that is configured and disposed for compressing a gas stream introduced into the parallel-flow regenerative shaft kiln, wherein the high-pressure fan is configured as an axial fan or as a radial fan and includes an impeller through which flow can take place axially or radially.

27. The parallel-flow regenerative shaft kiln of claim 26 comprising:
a combustion air inlet for letting combustion air and/or a fuel gas into the preheating zone and/or the calcining zone; and
a cooling air inlet for letting cooling air into the cooling zone,
wherein the combustion air inlet and/or the cooling air inlet is connected to the high-pressure fan or, respectively, to high-pressure fans.

28. The parallel-flow regenerative shaft kiln of claim 26 comprising an open-loop/closed-loop controller that is connected to a fuel inlet for letting in fuel gas and is configured to provide for an operating state for switchover between operation of a first shaft of the two shafts as the calcining shaft and operation of the first shaft as the regenerative shaft, wherein the open-loop/closed-loop controller is configured to stop feeding fuel gas through the fuel inlet during the switchover.

29. The parallel-flow regenerative shaft kiln of claim 28 wherein the open-loop/closed-loop controller is connected to the high-pressure fan and is configured to during the switchover reduce a speed of the high-pressure fan by not more than 50% to 65%.

30. The parallel-flow regenerative shaft kiln of claim 28 wherein each of the two shafts has an off-gas outlet for letting off-gases out of the respective shaft, wherein each off-gas outlet is connected to a fan, wherein the open-loop/closed-loop controller is configured to increase a speed of the fan during the switchover.

31. The parallel-flow regenerative shaft kiln of claim 30 wherein each off-gas outlet is connected via an off-gas conduit to the fan, wherein at least one off-gas shutoff facility is disposed in the off-gas conduit and is connected to the open-loop/closed-loop controller, wherein the open-loop/closed-loop controller is configured such that during the switchover the open-loop/closed-loop controller opens the off-gas shutoff facility following the increase of the speed of the fan.

32. The parallel-flow regenerative shaft kiln of claim 28 wherein each shaft of the two shafts has a product outlet for letting calcined material out of the respective shaft and has a pressure-measuring facility for ascertaining a pressure within the respective shaft, wherein the open-loop/closed-loop controller is connected to the product outlet and to the pressure-measuring facility of each shaft and is configured to open the respective product outlet if the pressure falls below a predetermined limit.

33. The parallel-flow regenerative shaft kiln of claim 26 wherein each shaft has a discharge system with a first product outlet for letting calcined material out of the respective shaft, a buffer store downstream of the first product outlet, and a second product outlet.

34. The parallel-flow regenerative shaft kiln of claim 28 wherein the high-pressure fan is a first high-pressure fan, the parallel-flow regenerative shaft kiln comprising a second high-pressure fan, wherein each high-pressure fan is assigned a shutoff facility that in a closed position prevents a flow of gas from the respective high-pressure fan into the shaft, wherein the open-loop/closed-loop controller is connected to the shutoff facility and is configured to move the shutoff facility into the closed position during the switchover.
